(19) United States
(12) Patent Application Publication
(10) Pub. No.: US 2013/0155369 A1
(43) Pub. Date: Jun. 20, 2013

(54) FOLDABLE GLASSES

(71) Applicant: Chin Lung Chen, Tainan City (TW)

(72) Inventor: Chin Lung Chen, Tainan City (TW)

(21) Appl. No.: 13/327,007

(22) Filed: Dec. 15, 2011

(51) Int. Cl. G02C 5/14

(52) U.S. Cl. 351/115

(57) ABSTRACT

Foldable glasses include a body having two lateral sides. A pivotal column is formed on each lateral side and received in an insertion groove of a lining block. The insertion groove of each lining block includes two clamping portions clamping one of the pivotal columns Each lining block is pivotable relative to one of the pivotal columns about the pivotal end. Two elongated temples each include an end having a receiving groove securely receiving one of the lining blocks. Each lining block is covered by the receiving groove of one of the temples when the temple is being pivoted. Each pivotal column abuts a stop portion of the insertion groove of one of the lining blocks when the temples are in the unfolded position. The first recessed portion of the insertion groove of each lining block receives one of the pivotal columns when the temples are in the folded position.

### BACKGROUND OF THE INVENTION

The present invention relates to foldable glasses and, more particularly, to foldable glasses that are easy to assemble while providing operational stability and appearance quality.

Glasses are a common personal accessory and generally include a body and two temples. The body includes a frame or a lens. Each temple is pivotably connected to the body so as to be unfolded or folded. However, the thickness of the glasses after folding is increased and, thus, causes inconvenience to carriage.

FIG. 10 shows conventional glasses including a body 1′ in the form of a lens, two pivotal blocks 2′, and two temples 3′. A peg 11′ is provided on each of two outer sides of the body 1′. Each pivotal block 2′ includes an end pivotably connected to one of the pegs 11′. Each temple 3′ is pivotably connected by a screw 21′ to the other end of one of the pivotal blocks 2′. Thus, the pivotal blocks 2′ can pivot relative to the body 1′, and the temples 3′ can be folded to abut upper and lower portions of the body 1′ so as to reduce the overall thickness of the folded glasses. However, the screws 21′ are required in assembling the temples 3′ with the pivotal blocks 2′, causing inconvenience to assembly. Furthermore, the pivotal connection between the pivotal blocks 2′ and the pegs 11′ is not reliable, such that the pivotal blocks 2′ are liable to disengage from the pegs 11′ while pivoting the pivotal blocks 2′. Further, the exposed pivotal blocks 2′ cause adverse affect to the appearance quality.

### BRIEF SUMMARY OF THE INVENTION

An objective of the present invention is to provide foldable glasses that include two lining blocks for pivotal connection with the temples to provide enhanced operational stability while providing appearance quality.

Foldable glasses according to the present invention includes a body having upper and lower portions spaced in a height direction and two lateral sides spaced in a width direction perpendicular to the height direction. A pivotal column is formed on each lateral side and includes an outer periphery and a pivotal end. The foldable glasses further include two lining blocks each having an insertion groove receiving one of the pivotal columns. The insertion groove of each lining block includes two clamping portions clamping the outer periphery of one of the pivotal columns Each lining block is pivotable relative to one of the pivotal columns about the pivotal end. The insertion groove of each lining block includes a stop portion and a first recessed portion. The foldable glasses further include two elongated temples each having a longer side. Each temple includes an end having a receiving groove extending perpendicularly to the longer side. The receiving groove of each temple securely receives one of the lining blocks and has a notch. Each pivotal column is extended through the notch of the receiving groove of one of the temples. Each temple is pivotable relative to the body through one of the lining blocks between a folded position and an unfolded position. Each lining block is covered by the receiving groove of one of the temples when the temple is being pivoted. Each pivotal column abuts the stop portion of the insertion groove of one of the lining blocks when the temples are in the unfolded position. The first recessed portion of the insertion groove of each lining blocks receives one of the pivotal columns when the temples are in the folded position.

Preferably, the outer periphery of each pivotal column has square cross sections between the pivotal end and one of the lateral sides of the body and has a first pair of parallel positioning faces and a second pair of parallel positioning face extending perpendicularly between the first pair of parallel positioning faces. The pivotal end of each pivotal column has an outer diameter larger than a spacing between the first pair of parallel positioning faces. The clamping portions of the insertion groove of each lining block are parallel to each other and clamp the first pair of parallel positioning faces or the second pair of parallel positioning faces of one of the pivotal columns. The insertion groove of each lining block further includes a second recessed portion opposite to the first recessed portion. The first and second recessed portions receive a spherical surface of the pivotal end. The stop portion extends perpendicular to the clamping portions. The first recessed portion has a length allowing each lining block to pivot 90° relative to the pivotal column A spacing between the clamping portions is equal to the spacing between the first pair of parallel positioning faces. Each clamping portion includes a positioning/pivoting hole receiving the spherical surface of the pivotal end, allowing each lining block to pivot relative to one of the pivotal columns about the pivotal end.

Preferably, an arcuate guiding face is formed between each of the first pair of parallel positioning faces and one of the second pair of parallel positioning faces.

Preferably, each lining block includes a protrusion on an outer face thereof. The receiving groove of each temple includes a receptacle. The protrusion of each lining block is engaged in the receptacle of one of the temples.

Preferably, the longer side of each temple includes two lateral walls defining a groove. The grooves of the temples respectively receive the upper and lower portions of the body when the temples are in the folded position.

The foldable glasses according to the present invention can be assembled without using any tool. Furthermore, the lining blocks are covered by the temples to provide appearance quality.

The present invention will become clearer in light of the following detailed description of illustrative embodiments of this invention described in connection with the drawings.

### DESCRIPTION OF THE DRAWINGS

FIG. 1 shows a partial, exploded, perspective view of foldable glasses according to the present invention.

FIG. 2 shows another partial, exploded, perspective view of the foldable glasses of FIG. 1.

FIG. 3 shows a perspective view of the foldable glasses of FIG. 1.

FIG. 4 shows a partial, cross sectional view of the foldable glasses of FIG. 1 according to section line A-A of FIG. 3.

FIG. 5 shows a schematic perspective view of the foldable glasses of FIG. 1, with two temples of the glasses pivoted relative to upper and lower portions of a body of the glasses.

FIG. 6A shows a partial, cross sectional view of the foldable glasses of FIG. 1 according to section line B-B of FIG. 3.

FIG. 6B shows a view similar to FIG. 6A, with the temple pivoted relative to the body.

FIG. 6C shows a view similar to FIG. 6B, with the temple further pivoted relative to the body.

FIG. 7 shows a partial, cross sectional view of the foldable glasses of FIG. 1. according to section line C-C of FIG. 5.

FIG. 8 shows a perspective view of the foldable glasses of FIG. 1, with the foldable glasses in a completely folded state.

FIG. 9 shows a partial, cross sectional view of the foldable glasses of FIG. 1 according to section line D-D of FIG. 8.

FIG. 10 shows a perspective view of conventional foldable glasses.

### DETAILED DESCRIPTION OF THE INVENTION

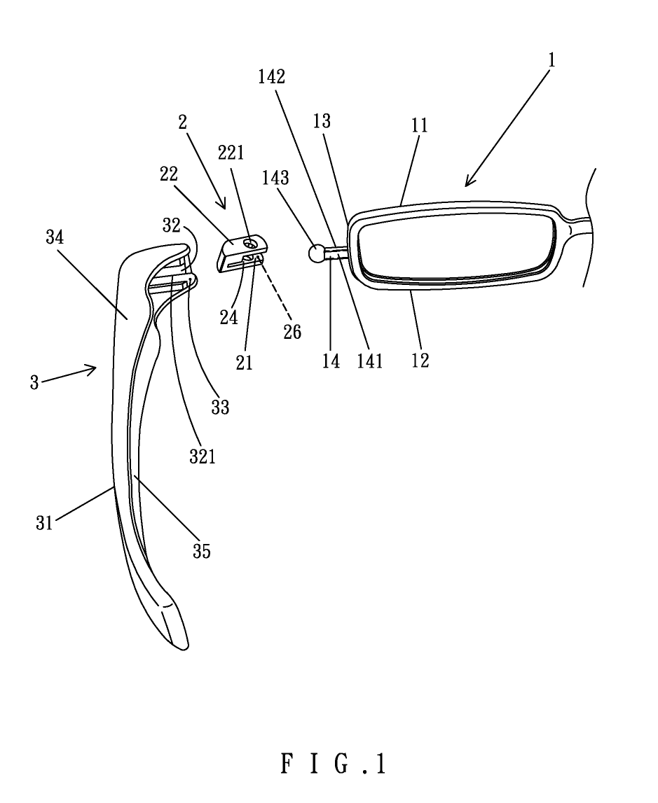

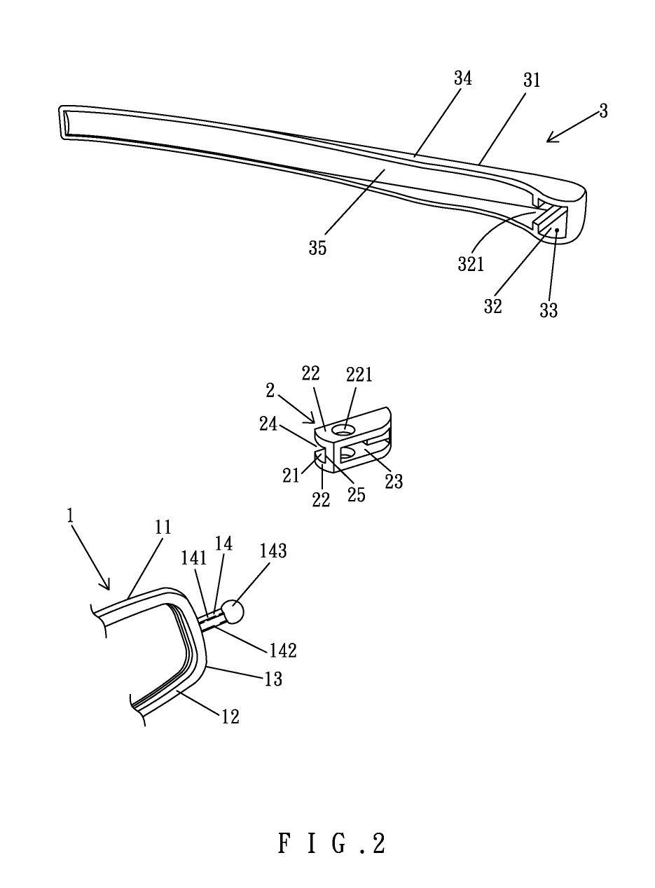

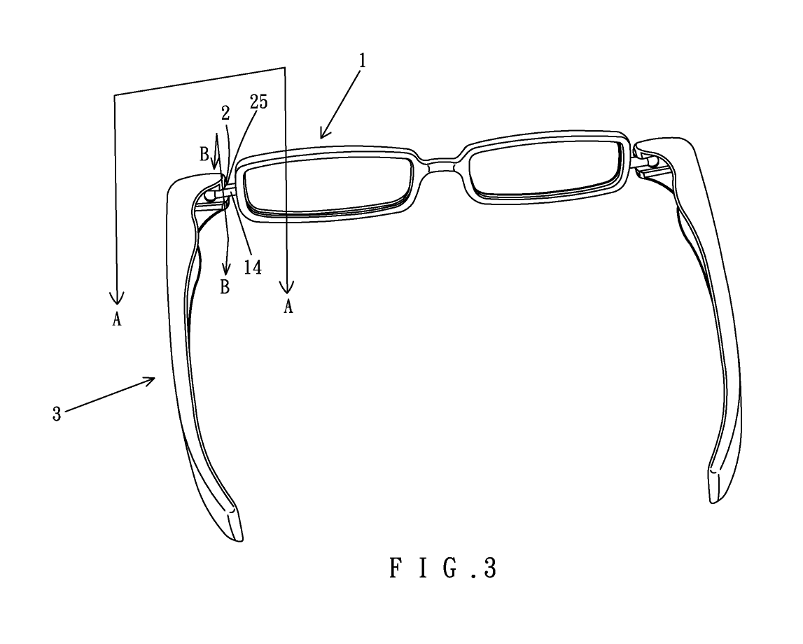

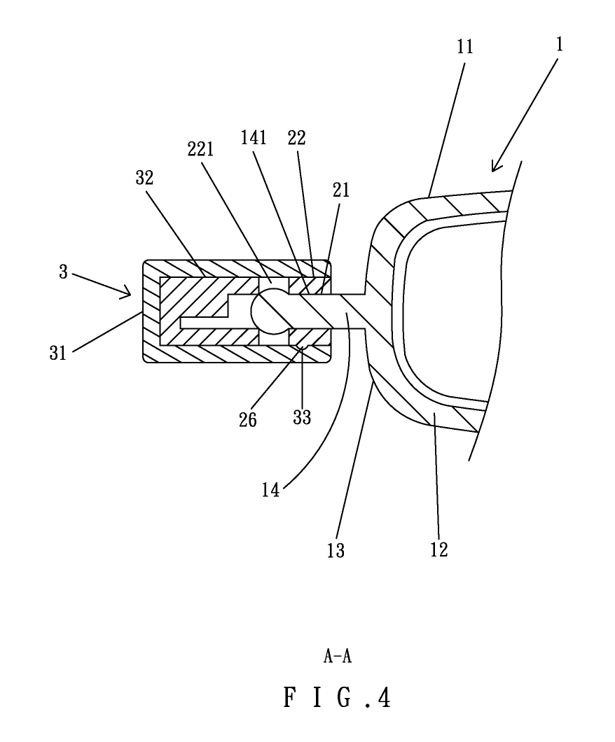

With reference to FIGS. 1-4, foldable glasses according to the present invention include a body 1 having upper and lower portions 11 and 12 spaced in a height direction and two lateral sides 13 spaced in a width direction perpendicular to the height direction. A pivotal column 14 is formed on each of the two lateral sides 13 and includes an outer periphery and a pivotal end 143. The outer periphery of each pivotal column 14 has square cross sections between pivotal end 143 and one of the lateral sides 13 of the body 1. Specifically, the outer periphery of each pivotal column 14 includes a first pair of parallel positioning faces 141 and a second pair of parallel positioning face 141 extending perpendicularly between the first pair of parallel positioning faces 141. The pivotal end 143 of each pivotal column 14 has an outer diameter larger than a spacing between the first pair of parallel positioning faces 141. An arcuate guiding face 142 is formed between each of the first pair of parallel positioning faces 141 and one of the second pair of parallel positioning faces 141.

The foldable glasses further include two lining blocks 2 each including an insertion groove 21 receiving one of the pivotal columns 14. The insertion groove 21 of each lining block 2 includes two clamping portions 22 clamping the outer periphery of one of the pivotal columns 14. The insertion groove 21 of each lining block 2 includes a first recessed portion 24 and a second recessed portion 23 opposite to the first recessed portion 24. The first recessed portion 24 has a length allowing each of the two lining blocks 2 to pivot 90° relative to the pivotal column 14. The first and second recessed portions 24 and 23 receive a spherical surface of one of the pivotal ends 143. A stop portion 25 extends perpendicular to the clamping portions 22. A spacing between the clamping portions 22 is equal to the spacing between the first pair of parallel positioning faces 141. Each clamping portion 22 includes a positioning/pivoting hole 221 receiving the spherical surface of the pivotal end 143, allowing each lining block 2 to pivot relative to one of the pivotal columns 14 about the pivotal end 143. Each lining block 2 further includes a protrusion 26 on an outer face thereof.

The foldable glasses further include two elongated temples 3 each having a longer side 31. Each temple 3 includes an end having a receiving groove 32 extending perpendicularly to the longer side 31 and extending in a direction corresponding to that of the insertion groove 21 of one of the lining blocks 2. The receiving groove 32 of each temple 3 securely receives one of the lining blocks 2 and has a notch 321. Each pivotal column 14 is extended through the notch 321 of the receiving groove 32 of one of the temples 3. The receiving groove 32 of each temple 3 includes a receptacle 33 in which the protrusion 26 of one of the lining blocks 2 is engaged. The longer side 31 of each temple 3 includes two lateral walls 34 defining a groove 35.

In assembly, the pivotal columns 14 of the body 1 are forcibly inserted into the insertion grooves 21 of the lining blocks 2 due to flexibility of the lining blocks 2. Different portions of the spherical surface of each pivotal end 143 are received in the positioning/pivoting hole 221 and the first and second recessed portions 24 and 23 of one of the lining blocks 2. The inner faces of the clamping portions 22 of each lining block 2 clamps the first or second pair of parallel positioning faces 141. After assembly, disengagement of the lining blocks 2 from the pivotal columns 14 is prevented by the restitution force of the flexible lining blocks 2. The flexibility of the receiving grooves 32 of the temples 3 allows the lining blocks 2 to be inserted into the receiving grooves 32, with the protrusions 26 of the lining blocks 2 received in the receptacles 33 of the temples 3. Thus, the temples 3 can rapidly be coupled to the lining blocks 2 to allow joint movement of each temple 3 and a corresponding lining block 2. Furthermore, the lining blocks 2 are covered by the temples 3 to provide enhanced appearance quality.

Each temple 3 is pivotable relative to the body 1 through one of the lining blocks 2 between a folded position and an unfolded position. Each lining block 2 is covered by the receiving groove 32 of one of the temples 3 when the temple 3 is being pivoted. Each pivotal column 14 abuts the stop portion 25 of the insertion groove 21 of one of the flexible lining blocks 2 when the temples 3 are in the unfolded position. Since different portions of the spherical surface of each pivotal end 143 are received in the positioning/pivoting hole 221 and the first and second recessed portions 24 and 23 of one of the lining blocks 2, since the clamping portions 22 clamps the first or second pair of parallel positioning faces 141, and since the inner faces of the receiving groove 32 of each temple 3 clamps a corresponding lining block 2, the temples 3 can reliably be positioned in the folded position.

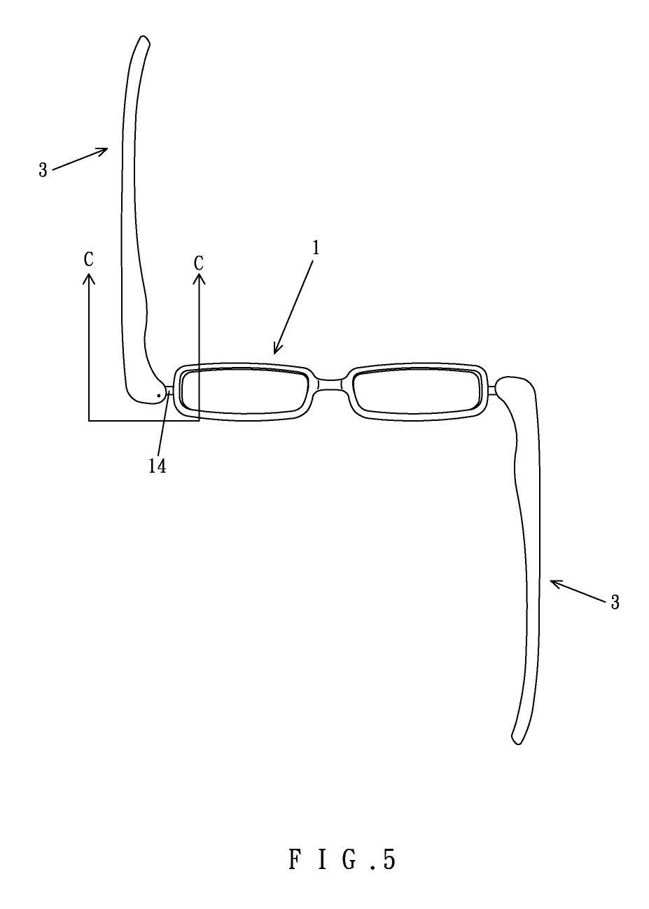

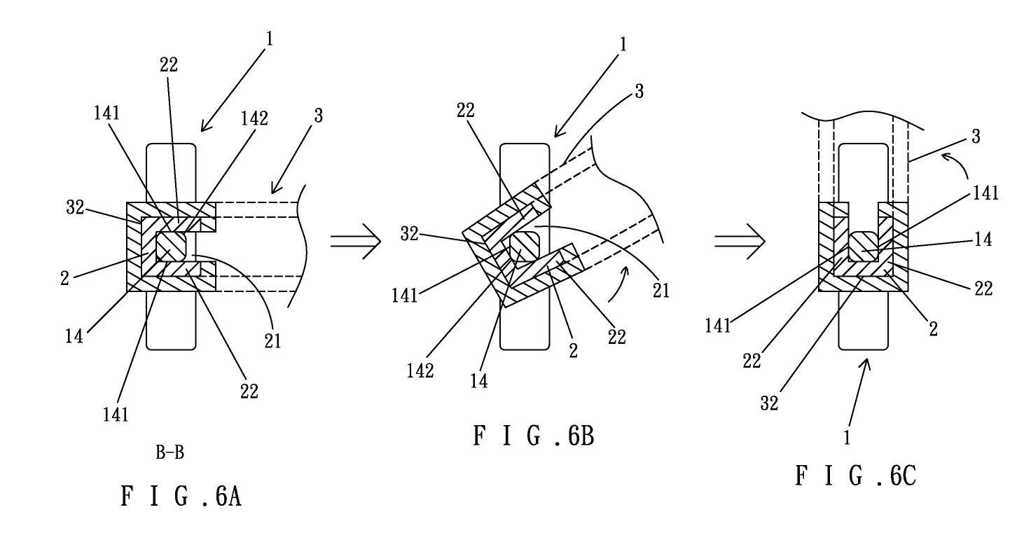

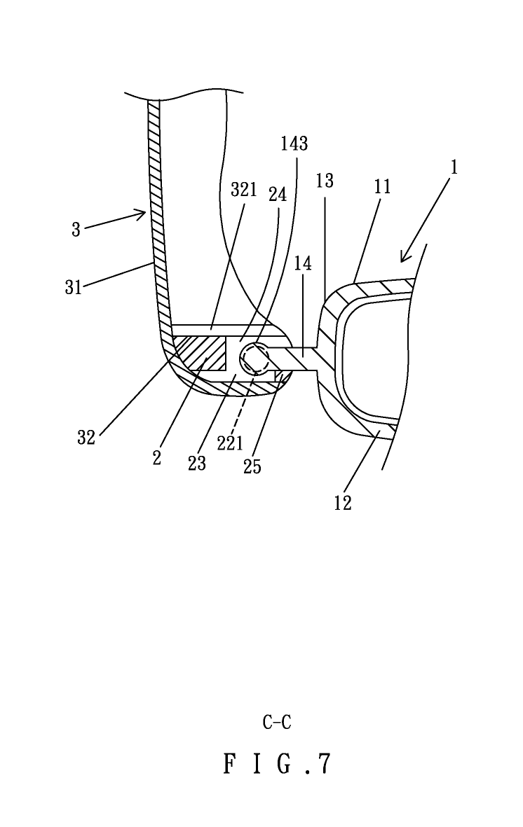

With reference to FIGS. 5, 6A, 6B, 6C, and 7, when folding the temples 3, one of the temples 3 is pivoted upward 90° and the other is pivoted downward 90°. The insertion grooves 21 of the lining blocks 2 and the receiving grooves 32 of the temples 3 expand due to flexibility, and the spherical surface 142 of each pivotal end 143 allows smooth rotation in the lining 2, as shown in FIGS. 6A-6C. When the temples 3 reach the locations in alignment with the upper and lower portions 11 and 12 of the body 1, the positioning/pivoting hole 221 and the first and second recessed portions 24 and 23 of each lining block 2 receive other different portions of the spherical surface of the corresponding pivotal end 143. Furthermore, the clamping portions 22 clamp the other pair of parallel positioning faces 141. Further, the inner faces of the receiving groove 32 of each temple 3 clamps a corresponding lining block 2. Thus, the temples 3 can reliably be positioned in any location.

Since the lining blocks 2 are remained in the receiving grooves 32 of the temples 3, excessive expansion of the insertion grooves 21 of the lining blocks 2 during rotation of the lining blocks 2 is prevented, avoiding unreliable engagement with the pivotal columns 14. Thus, the temples 3 will not disengage from the body 1 while the temples 3 are being pivoted, providing enhanced operational stability and reliability.

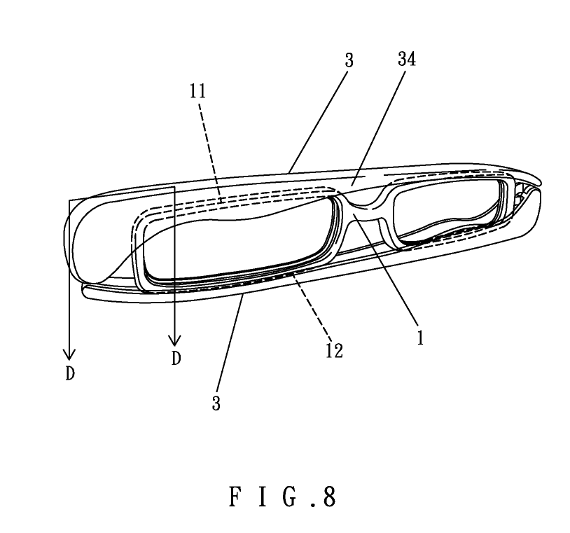

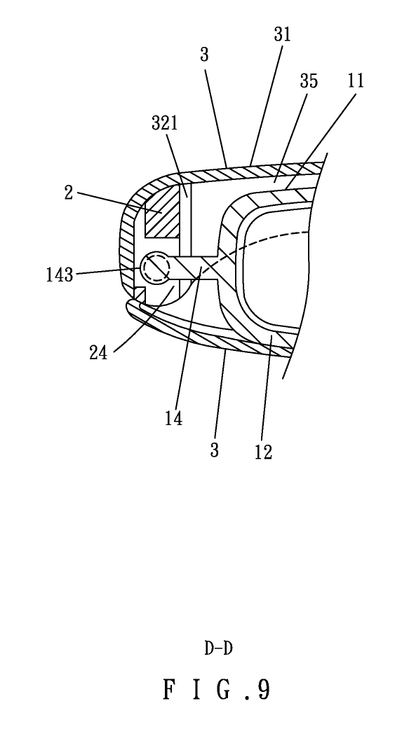

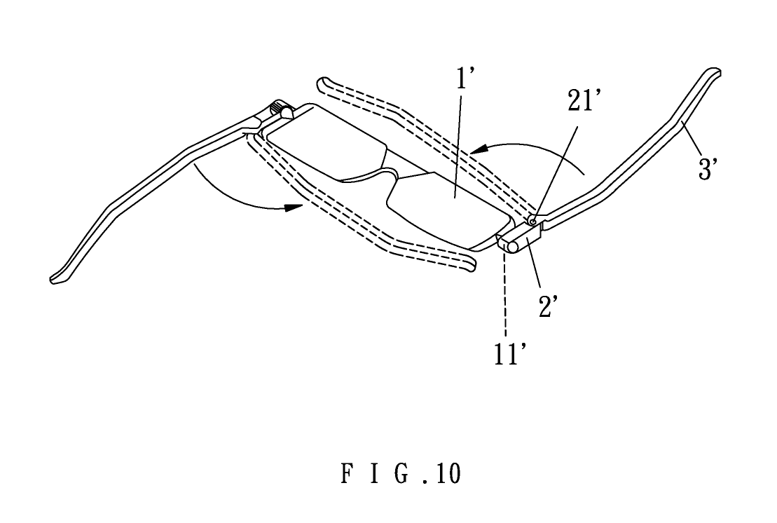

With reference to FIGS. 8 and 9, after the temples 3 are pivoted to the folded position, the first recessed portion 24 of the insertion groove 21 of each lining block 2 receives one of the pivotal columns 14. Furthermore, the grooves 35 of the temples 3 respectively receive the upper and lower portions 11 and 12 of the body 1. Thus, the body 1 can be protected when the temples are in the folded position.

In view of the foregoing, the lining blocks 2 are remained in the temples 3 during pivotal movement, providing enhanced pivotal reliability while preventing the temples 3 from disengaging from the body 1. Although each lining block 2 can be integrally formed with a corresponding temple 3 as a single, inseparable member, the disengagement-preventing effect is not as satisfactory as the lining blocks 2 separate from the temples 3.

The foldable glasses according to the present invention provide assembling convenience, appearance quality, assembling reliability, operational reliability, and protection of the body 1, providing functions better than conventional products. In a case that the receiving grooves 32 of the temples 3 are in tight fitting with the lining blocks 2, the lining blocks 2 do not have to include the protrusions 26, and the temples 3 do not have to include the receptacles 33.

Although specific embodiments have been illustrated and described, numerous modifications and variations are still possible without departing from the essence of the invention. The scope of the invention is limited by the accompanying claims.

1. Foldable glasses comprising:
a body including upper and lower portions spaced in a height direction and two lateral sides spaced in a width direction perpendicular to the height direction, with a pivotal column formed on each of the two lateral sides and including an outer periphery and a pivotal end;
two lining blocks each including an insertion groove receiving one of the pivotal columns, with the insertion groove of each of the two lining blocks including two clamping portions clamping the outer periphery of one of the pivotal columns, with each of the two lining blocks pivotable relative to one of the pivotal columns about the pivotal end, with the insertion groove of each of the two lining blocks including a stop portion and a first recessed portion;
two elongated temples each having a longer side, with each of the two temples including an end having a receiving groove extending perpendicularly to the longer side, with the receiving groove of each of the two temples securely receiving one of the two lining blocks and having a notch, with each of the pivotal columns extended through the notch of the receiving groove of one of the two temples, with each of the two temples pivotable relative to the body through one of the two lining blocks between a folded position and an unfolded position, with each of the two lining blocks covered by the receiving groove of one of the two temples when the temple is being pivoted, with each of the pivotal columns abutting the stop portion of the insertion groove of one of the two lining blocks when the temples are in the unfolded position, with the first recessed portion of the insertion groove of each of the two lining blocks receiving one of the pivotal columns when the two temples are in the folded position.

2. The foldable glasses as claimed in claim 1, with the receiving groove of each of the two temples extending in a direction corresponding to that of the insertion groove of one of the two lining blocks.

3. The foldable glasses as claimed in claim 2, with the outer periphery of each of the pivotal columns having square cross sections between the pivotal end and one of the lateral sides of the body and having a first pair of parallel positioning faces and a second pair of parallel positioning face extending perpendicularly between the first pair of parallel positioning faces, with the pivotal end of each of the pivotal columns having an outer diameter larger than a spacing between the first pair of parallel positioning faces, with the two clamping portions of the insertion groove of each of the two lining blocks being parallel to each other and clamping the first pair of parallel positioning faces or the second pair of parallel positioning faces of one of the pivotal columns, with the insertion groove of each of the two lining blocks further including a second recessed portion opposite to the first recessed portion, with the first and second recessed portions receiving a spherical surface of the pivotal end, with the stop portion extending perpendicular to the two clamping portions, with the first recessed portion having a length allowing each of the two lining blocks to pivot 90° relative to the pivotal column, with a spacing between the two clamping portions equal to the spacing between the first pair of parallel positioning faces, with each of the two clamping portions including a positioning/pivoting hole receiving the spherical surface of the pivotal end, allowing each of the two lining blocks to pivot relative to one of the pivotal columns about the pivotal end.

4. The foldable glasses as claimed in claim 3, with an arcuate guiding face formed between each of the first pair of parallel positioning faces and one of the second pair of parallel positioning faces.

5. The foldable glasses as claimed in claim 1, with each of the two lining blocks including a protrusion on an outer face thereof, with the receiving groove of each of the two temples including a receptacle, with the protrusion of each of the two lining blocks engaged in the receptacle of one of the two temples.

6. The foldable glasses as claimed in claim 1, with the longer side of each of the two temples including two lateral walls defining a groove, with the grooves of the two temples respectively receiving the upper and lower portions of the body when the two temples are in the folded position.
